(19) United States
(12) Patent Application Publication
(10) Pub. No.: US 2025/0388752 A1
(43) Pub. Date: Dec. 25, 2025

(54) RESIN COMPOSITION FOR PRODUCING CARBON MOLDED BODY BY THREE-DIMENSIONAL PRINTER MOLDING AND CARBONIZATION

(71) Applicant: MITSUBISHI PENCIL COMPANY, LIMITED, Tokyo (JP)

(72) Inventors: Hideyuki IKOMA, Tokyo (JP); Atsunori SATAKE, Fujioka-shi (JP)

(73) Assignee: MITSUBISHI PENCIL COMPANY, LIMITED, Tokyo (JP)

(21) Appl. No.: 18/850,165

(22) PCT Filed: Mar. 22, 2023
(86) PCT No.: PCT/JP2023/011214

§ 371 Date: Sep. 24, 2024

(30) Foreign Application Priority Data
Mar. 31, 2022 (JP) 2022-060530

(51) Int. Cl. C08L 79/08; B33Y 70/10; C08K 3/04; C08K 7/06

(52) U.S. Cl. CPC C08L 79/08; B33Y 70/10; C08K 3/04; C08K 7/06; C08L 2205/025

(57) ABSTRACT

A resin composition may be used for producing a carbon molded body by three-dimensional printer molding and carbonization. Such a resin may include a first thermoplastic resin having a residual carbon rate of less than 50%, a second thermoplastic resin having a residual carbon rate of 50% or more, and a carbonaceous filler dispersed through the thermoplastic resins.

### FIELD

The present invention relates to a resin composition for three-dimensional printers, particularly a resin composition that can be molded by a three-dimensional printer and can maintain a shape when carbonized.

### BACKGROUND

Three-dimensional (3D) printers are devices for a technology for shaping a three-dimensional object by calculating the shapes of thin cross-sections from three-dimensional data input from a CAD or the like and depositing a material in layers based on the calculation results, and this technology is also referred to as “additive manufacturing technology”. Three-dimensional printers have been attracting attention as a high-mix low-volume manufacturing technology, since they require no mold assembly used in injection molding, and are capable of shaping complex three-dimensional structures which could not be obtained by injection molding.

As materials for three-dimensional printers (also referred to as “additive manufacturing materials”), various materials have been developed in accordance with the method and use of three-dimensional printers and photocurable resins, thermoplastic resins, metals, ceramics, and waxes, for example, are used as main materials.

Based on the mode of three-dimensionally shaping a material, the methods of three-dimensional printers are classified into, for example, (1) binder jetting method, (2) directed-energy deposition method, (3) material extrusion method, (4) material jetting method, (5) powder bed fusion method, (6) sheet lamination method, and (7) vat photopolymerization method. Three-dimensional printers adopting the material extrusion method (also referred to as “fused deposition modeling method”) among the above-described methods have been increasingly reduced in price, and the demand for these printers is thus growing for household and office use. Further, for three-dimensional printers adopting the powder bed fusion method, systems realizing an improvement in the recyclability of powder materials have been developed, and the powder bed fusion is a method that has been attracting attention.

The fused deposition modeling method (material extrusion method) is a method of shaping an object by fluidizing a thermoplastic resin having the shape of a thread referred to as “filament” or the like with a heating means provided inside an extrusion head, discharging the thus fluidized resin through a nozzle onto a platform, and then cooling and solidifying the resin while gradually depositing the resin in layers in accordance with the cross-sectional shapes of a desired shaped object.

Various compositions have been disclosed as resin compositions for three-dimensional printers adopting such a fused deposition modeling method.

PTL 1 discloses a resin composition as a shaping material for a three-dimensional printer, which resin composition contains inorganic fibers having an average fiber length of 1 μm to 300 μm and an average aspect ratio of 3 to 200, and a thermoplastic resin.

PTL 2 discloses a filament for a fused deposition modeling-type three-dimensional printer, which is characterized by being formed of a functional resin composition that contains a thermoplastic matrix resin and a functional nanofiller dispersed in the thermoplastic matrix resin.

### CITATION LIST

### Patent Literature

[PTL 1] WO 2018/043231
[PTL 2] JP 2016-28887

### SUMMARY

### Technical Problem

Molded bodies that can be produced by conventional three-dimensional printers are resin-based molded bodies.

In this respect, the present invention provides a resin composition which can be molded by a three-dimensional printer, and with which a molded body obtained therefrom can yield a carbon molded body through carbonization.

### Solution to Problem

The present inventors intensively studied to discover that the above-described problem can be solved by the following means, thereby completing the present invention. In other words, the present invention encompasses the following.

### <Aspect 1>

A resin composition for producing a carbon molded body by three-dimensional printer molding and carbonization, the resin composition containing:
a first thermoplastic resin having a residual carbon ratio of lower than 50%;
a second thermoplastic resin having a residual carbon ratio of 50% or higher; and
a carbonaceous filler dispersed in these thermoplastic resins.

### <Aspect 2>

The resin composition according to Aspect 1, having a melt mass flow rate of 10 to 35 g/10 min or more in accordance with JIS K7210-01 when measured at a temperature of 360° C. and a load of 2.16 kgf.

### <Aspect 3>

The resin composition according to Aspect 1 or 2, wherein the first thermoplastic resin has a melting point higher than that of the second thermoplastic resin as measured by a thermogravimetric-differential thermal analysis (TG-DTA) in a nitrogen atmosphere at a heating rate of 10° C./min.

### <Aspect 4>

The resin composition according to any one of Aspects 1 to 3, wherein the first thermoplastic resin has a thermal decomposition temperature lower than that of the second thermoplastic resin as measured by a thermogravimetric-differential thermal analysis (TG-DTA) in a nitrogen atmosphere at a heating rate of 10° C./min.

### <Aspect 5>

The resin composition according to any one of Aspects 1 to 4, wherein the first and the second thermoplastic resins are both a polyimide resin.

### <Aspect 6>

The resin composition according to Aspect 5, wherein the first thermoplastic resin is a thermoplastic polyimide.

### <Aspect 7>

The resin composition according to Aspect 5 or 6, wherein the first thermoplastic resin is a polyetherimide.

### <Aspect 8>

The resin composition according to any one of Aspects 1 to 7, wherein the content of the carbonaceous filler is 10 to 40% by mass with respect to the mass of the whole resin composition.

### <Aspect 9>

The resin composition according to any one of Aspects 1 to 8, wherein the carbonaceous filler is a carbon fiber.

### Advantageous Effects of Invention

According to the present invention, a resin composition which can be molded by a three-dimensional printer, and with which a molded body obtained therefrom can yield a carbon molded body through carbonization, can be obtained.

### DESCRIPTION OF EMBODIMENTS

### <<Resin Composition>

The resin composition of the present invention for producing a carbon molded body by three-dimensional printer molding and carbonization contains:
a first thermoplastic resin having a residual carbon ratio of lower than 50%;
a second thermoplastic resin having a residual carbon ratio of 50% or higher; and
a carbonaceous filler dispersed in these thermoplastic resins.

In other words, the present invention also relates to the use of the above-described resin composition for producing a carbon molded body by three-dimensional printer molding and carbonization.

Regarding the present invention, the term “residual carbon ratio” refers to a value measured in the following manner.

### (Residual Carbon Ratio)

Using a thermobalance, a resin of interest is heated from room temperature to 900° C. at a heating rate of 20° C./min in a nitrogen atmosphere, and the residual carbon ratio (% by mass) is calculated using the following equation, taking the mass at 850° C. as the mass after firing.

Residual Carbon Ratio (%)=(Mass after firing (850° C.)/Mass before firing)×100

The present inventors discovered that, by the above-described constitution, a resin composition which can not only be molded by a three-dimensional printer but also maintain its shape after carbonization can be obtained. Without wishing to be bound by any theory, this is believed to be because, while a combination of the first thermoplastic resin having a low residual carbon ratio and the carbonaceous filler contributes to maintaining a pre-carbonization shape even after carbonization, the second thermoplastic resin having a high residual carbon ratio contributes to the moldability by a three-dimensional printer.

The melt mass flow rate of the resin composition of the present invention according to JIS K7210-1 may be 10 g/10 min or more, 12 g/10 min or more, 15 g/10 min or more, 17 g/10 min or more, or 20 g/10 min or more, and 100 g/10 min or less, 70 g/10 min or less, 50 g/10 min or less, 40 g/10 min or less, 35 g/10 min or less, or 30 g/10 min or less, when measured at a temperature of 360° C. and a load of 2.16 kgf.

The resin composition of the present invention may have a melting point of 300° C. or higher, 310° C. or higher, 320° C. or higher, 330° C. or higher, 340° C. or higher, 350° C. or higher, 360° C. or higher, or 370° C. or higher, and 450° C. or lower, 440° C. or lower, 430° C. or lower, 420° C. or lower, 410° C. or lower, 400° C. or lower, 390° C. or lower, or 380° C. or lower.

The resin composition of the present invention may have a thermal decomposition temperature of 380° C. or higher, 390° C. or higher, 400° C. or higher, 410° C. or higher, or 420° C. or higher, and 550° C. or lower, 540° C. or lower, 530° C. or lower, 520° C. or lower, 510° C. or lower, or 500° C. or lower.

In the present invention, the melting point and the thermal decomposition temperature can be measured by a thermogravimetric-differential thermal analysis (TG-DTA) performed in a nitrogen atmosphere at a heating rate of 10° C./min. Specifically, the melting point and the thermal decomposition temperature can be determined by heating a sample in a nitrogen atmosphere at a heating rate of 10° C./min, and obtaining a curve (TG curve) in which the mass and the temperature are plotted on the ordinate and the abscissa, respectively, as well as a curve (DTA curve) in which the temperature difference and the temperature are plotted on the ordinate and the abscissa, respectively, by a thermogravimetric-differential thermal analysis (TG-DTA) according to JIS K0129. More specifically, when an endothermic peak is observed in the DTA curve at a position where a reduction in mass is not observed in the TG curve, the temperature assuming a minimum value of the peak can be defined as the melting point. Further, when a reduction in mass is observed in the TG curve, the temperature at which the reduction in mass starts can be defined as the thermal decomposition temperature.

From the standpoint of obtaining a favorable mixed state of the first and the second thermoplastic resins and thereby improving the moldability by three-dimensional printing, it is preferred that both of the first and the second thermoplastic resins be of the same kind, particularly a polyimide resin.

The resin composition of the present invention may also contain optional particles other than the carbonaceous filler.

The constituents of the present invention will now be described.

### <First Thermoplastic Resin>

The first thermoplastic resin is a thermoplastic resin having a residual carbon ratio of lower than 50%. This residual carbon ratio may be 48% or lower, 45% or lower, 42% or lower, 40% or lower, 38% or lower, or 35% or lower, and 15% or higher, 18% or higher, 20% or higher, 22% or higher, or 25% or higher.

As the first thermoplastic resin, for example, a thermoplastic polyimide (TPI) can be used. As the thermoplastic polyimide, a commercially available product can be used.

From the standpoint of obtaining a molded body after carbonization, the content of the first thermoplastic resin is preferably 10% by mass or more, or 15% by mass or more, with respect to the mass of the whole resin composition. This content may be 50% by mass or less, 45% by mass or less, 40% by mass or less, or 35% by mass or less.

The melt mass flow rate of the first thermoplastic resin according to JIS K7210-1 may be 0.1 g/10 min or more, 0.5 g/10 min or more, or 1.0 g/10 min or more, and 10.0 g/10 min or less, 5.0 g/10 min or less, 3.0 g/10 min or less, or 2.5 g/10 min or less, when measured at a temperature of 360° C. and a load of 2.16 kgf.

The melting point of the first thermoplastic resin may be 250° C. or higher, 260° C. or higher, 270° C. or higher, 280° C. or higher, 290° C. or higher, 300° C. or higher, 310° C. or higher, or 315° C. or higher, and 400° C. or lower, 390° C. or lower, 380° C. or lower, 370° C. or lower, 360° C. or lower, 350° C. or lower, 340° C. or lower, 330° C. or lower, or 325° C. or lower.

The melting point of the first thermoplastic resin may be higher than the melting point of the second thermoplastic resin and, for example, may be higher than the melting point of the second thermoplastic resin by 20° C. or more, 30° C. or more, 40° C. or more, 50° C. or more, or 55° C. or more.

The thermal decomposition temperature of the first thermoplastic resin may be 380° C. or higher, 390° C. or higher, 400° C. or higher, 410° C. or higher, 420° C. or higher, or 430° C. or higher, and 500° C. or lower, 490° C. or lower, 480° C. or lower, 470° C. or lower, 460° C. or lower, 450° C. or lower, or 440° C. or lower.

The thermal decomposition temperature of the first thermoplastic resin may be lower than the thermal decomposition temperature of the second thermoplastic resin and, for example, may be lower than the thermal decomposition temperature of the second thermoplastic resin by 20° C. or more, 30° C. or more, 40° C. or more, 50° C. or more, or 55° C. or more.

### <Second Thermoplastic Resin>

The second thermoplastic resin is a thermoplastic resin having a residual carbon ratio of 50% or higher. This residual carbon ratio may be 52% or higher, 55% or higher, 57% or higher, 60% or higher, or 62% or higher, and 80% or lower, 78% or lower, 75% or lower, 72% or lower, 70% or lower, or 67% or lower.

From the standpoint of obtaining the above-described effects, the residual carbon ratio of the second thermoplastic resin is preferably higher than that of the first thermoplastic resin by 20% or more, 25% or more, 30% or more, or 35% or more.

As the second thermoplastic resin, for example, a polyetherimide (PEI) can be used. As the polyetherimide, a commercially available product can be used. Particularly, when a thermoplastic polyimide (TPI) is used as the first thermoplastic resin, the use of a polyetherimide (PEI) as the second thermoplastic resin makes the first and the second thermoplastic resins be both an imide-based resin, so that a high compatibility of the first and the second thermoplastic resins can be obtained.

From the standpoint of the shapeability by a three-dimensional printer, the content of the second thermoplastic resin is preferably 10% by mass or more, 15% by mass or more, 20% by mass or more, 25% by mass or more, 30% by mass or more, or 35% by mass or more, with respect to the mass of the whole resin composition. This content may be 80% by mass or less, 75% by mass or less, 70% by mass or less, or 65% by mass or less.

The melt mass flow rate of the second thermoplastic resin according to JIS K7210-1 may be 5 g/10 min or more, 7 g/10 min or more, 10 g/10 min or more, or 12 g/10 min or more, and 30 g/10 min or less, 25 g/10 min or less, 20 g/10 min or less, 17 g/10 min or less, or 15 g/10 min or less, when measured at a temperature of 340° C. and a load of 5.00 kgf.

The melting point of the second thermoplastic resin may be 200° C. or higher, 210° C. or higher, 220° C. or higher, 230° C. or higher, 240° C. or higher, 250° C. or higher, or 260° C. or higher, and 370° C. or lower, 360° C. or lower, 350° C. or lower, 340° C. or lower, 330° C. or lower, 320° C. or lower, 310° C. or lower, 300° C. or lower, 290° C. or lower, 280° C. or lower, or 270° C. or lower.

The thermal decomposition temperature of the second thermoplastic resin may be 400° C. or higher, 410° C. or higher, 420° C. or higher, 430° C. or higher, 440° C. or higher, 450° C. or higher, 460° C. or higher, or 470° C. or higher, and 550° C. or lower, 540° C. or lower, 530° C. or lower, 520° C. or lower, 510° C. or lower, 500° C. or lower, 490° C. or lower, or 480° C. or lower.

### <Carbonaceous Filler>

The carbonaceous filler may be carbon fibers and/or carbon particles that are dispersed in the first and the second thermoplastic resin. In a carbon molded body obtained after carbonization, the carbonaceous filler is dispersed in amorphous carbon. Particularly, from the standpoint of maintaining the shape of the molded body obtained after carbonization, it is preferred to use carbon fibers.

Examples of the carbon fibers include, but are not limited to, milled fibers and chopped fibers. These fibers may be used singly or in combination.

The carbon fibers may have an average length of 10 μm or more, 15 μm or more, 20 μm or more, 25 μm or more, 30 μm or more, 35 μm or more, 40 μm or more, 45 μm or more, 50 μm or more, 55 μm or more, 60 μm or more, 65 μm or more, 70 μm or more, 75 μm or more, 80 μm or more, 85 μm or more, or 90 μm or more, and 800 μm or less, 700 μm or less, 600 μm or less, 500 μm or less, 400 μm or less, 300 μm or less, 200 μm or less, 180 μm or less, 150 μm or less, 120 μm or less, or 110 μm or less.

The carbon fibers may have an average fiber diameter of 1 μm or more, 3 μm or more, 5 μm or more, or 7 μm or more, and 20 μm or less, 15 μm or less, 12 μm or less, or 10 μm or less. The average length of the carbon fibers can be determined by, under a scanning electron microscope (SEM) or the like, randomly selecting and observing at least 50 fibers, measuring their lengths, and calculating the number average thereof.

Examples of the carbon particles include particles of graphene, carbon nanotubes, graphite, carbon black, and the like. These particles may be used singly or in combination.

A shape of the carbon particles is not particularly limited and, for example, the carbon particles may have a flat shape, an array shape, or a spherical shape.

The carbon particles may have an average particle size of 100 nm or more, 200 nm or more, 300 nm or more, 500 nm or more, 700 nm or more, 1 μm or more, 2 μm or more, or 3 μm or more, and 20 μm or less, 15 μm or less, 10 μm or less, or 7 μm or less. The term “average particle size” used herein means a median diameter (D50) calculated based on volume by laser diffractometry.

From the standpoint of maintaining a shape, the content of the carbonaceous filler in the resin composition is preferably 5% by mass or more, 10% by mass or more, or 15% by mass or more, with respect to the mass of the whole resin composition. This content may be 45% by mass or less, 40% by mass or less, or 35% by mass or less.

### <Other Particles>

As the particles other than the carbonaceous filler, for example, resin particles and metallic particles can be used.

As the resin particles, for example, acrylic resin particles can be used. As the acrylic resin particles, for example, particles of poly(meth)acrylic acid, polymethyl (meth)acrylate, polyethyl (meth)acrylate, polypropyl (meth)acrylate, polybutyl (meth)acrylate, polyisobutyl acrylate, polypentyl (meth)acrylate, polyhexyl (meth)acrylate, or poly-2-ethylhexyl (meth)acrylate can be used.

As the metallic particles, for example, at least one selected from the group consisting of particles of simple metals, metal oxides, metal carbides, and metal nitrides, particularly particles of a simple metal can be used. More specifically, at least one selected from the group consisting of particles of simple metals such as titanium (Ti), tungsten (W), molybdenum (Mo), iron (Fe), aluminum (Al), copper (Cu), silver (Ag), and gold (Au), and particles of oxides, carbides, and nitrides of these metals can be used.

The above-described other particles may have an average particle size of 10 nm or more, 20 nm or more, 30 nm or more, 50 nm or more, 70 nm or more, 100 nm or more, 200 nm or more, 300 nm or more, 500 nm or more, 700 nm or more, or 1 μm or more, and 5.0 μm or less, 4.0 μm or less, 3.0 μm or less, 2.0 μm or less, 1.5 μm or less, or 1.3 μm or less. With regard to a method of measuring the average particle size, reference can be made to the description relating to the carbonaceous filler.

The content of the other particles in the resin composition may be 5% by mass or more, 10% by mass or more, or 15% by mass or more, and 45% by mass or less, 40% by mass or less, or 35% by mass or less, with respect to the mass of the whole resin composition.

### <<Method of Producing Carbon Molded Body>>

The method of producing a carbon molded body according to the present invention includes:
three-dimensionally printing the above-described resin composition to provide a resin molded body; and
heat-treating the resin molded body in a non-oxidizing atmosphere and thereby carbonizing the resin molded body to provide a carbon molded body.

### <Provision of Resin Molded Body>

A resin molded body is provided by three-dimensionally printing the above-described resin composition.

A three-dimensional printing method employed in the present invention is not particularly limited and may be, for example, a material extrusion method (fused deposition modeling method).

### <Provision of Carbon Molded Body>

A carbon molded body is provided by heat-treating the above-described resin molded body in a non-oxidizing atmosphere, thereby carbonizing the resin molded body.

As the non-oxidizing atmosphere, for example, an inert gas atmosphere such as nitrogen gas, argon gas, or helium gas, or a reducing atmosphere such as a hydrogen-containing nitrogen gas may be used and, particularly, a nitrogen gas atmosphere is preferably used since it is easy to hand and inexpensive. It should be noted here that the non-oxidizing atmosphere may contain oxygen in a range where layers disposed by three-dimensional printing can be carbonized while complete combustion thereof is inhibited. The non-oxidizing atmosphere may contain oxygen in a range of, for example, 5% by volume or less, 3% by volume or less, or 1% by volume or less, or the non-oxidizing atmosphere may contain no oxygen.

The temperature of the heat treatment may be, for example, 600° C. or higher, 650° C. or higher, 700° C. or higher, 750° C. or higher, 800° C. or higher, 850° C. or higher, or 900° C. or higher, and 1,200° C. or lower, 1,150° C. or lower, 1,100° C. or lower, 1,050° C. or lower, or 1,000° C. or lower.

### EXAMPLES

The present invention will now be described concretely by way of Examples and Comparative Examples; however, the present invention is not limited thereto.

### <<Production of Resin Composition>>

Resin compositions of Examples 1 and 2 and Comparative Examples 1 to 3 were obtained by kneading the materials shown in Table 1 at the respective contents shown in Table 1. The details of the materials shown in Table 1 are as follows.
TPI: crude thermoplastic polyimide (residual carbon ratio: 24.1%)
PEI: polyetherimide (residual carbon ratio: 59.9%)
Carbon fiber: carbon fiber (length: 30 to 200 μm, average fiber diameter: about 8 μm)

The melting point and the thermal decomposition temperature of each of the thus obtained resin compositions were measured by a thermogravimetric-differential thermal analysis (TG-DTA) in a nitrogen atmosphere at a heating rate of 10° C./min.

Further, the melt mass flow rate (MFR) of each of the thus obtained resin compositions was measured at a temperature of 360° C. and a load of 2.16 kgf (at a temperature of 340° C. and a load of 5.00 kgf for Comparative Example 2).

### <<Evaluation>>

### <Three-Dimensional Moldability>

An attempt was made to mold each of the above-obtained resin compositions using a three-dimensional printer, and the resulting molded body was checked by visual observation. The evaluation results are as follows.
A: An input shape was output.
B: An input shape was not output.

### <Shape Retention After Carbonization>

The above-obtained resin compositions were each molded into a prescribed block shape by extrusion molding to obtain a resin molded body for evaluation of the shape after carbonization. Subsequently, the resin molded body was heat-treated at 1,000° C. for 50 hours in a non-oxidizing atmosphere and thereby carbonized to obtain a carbon molded body. The shape of the thus obtained carbon molded body was checked by visual observation. The evaluation criteria are as follows.
A: A molded body having a shape substantially the same as the pre-carbonization shape was obtained.
B: A molded body having a shape markedly changed from the pre-carbonization shape was obtained, or a molded body was not obtained.

The constitutions and evaluation results of Examples and Comparative Examples are shown in Table 1.

TABLE 1

| | Constitution | | | | | | | | | Evaluation results | |
|---|---|---|---|---|---|---|---|---|---|---|---|
| | First thermoplastic | | Second thermoplastic | | | | | | | | Shape |
| | resin | | resin | | Carbonaceous filler | | | | | | retention |
| | | Content | | Content | | Content | Melting | Decomposition | | Three- | after |
| | | (% by | | (% by | | (% by | point | temperature | MFR | dimensional | carbon- |
| | Type | mass) | Type | mass) | Type | mass) | (° C.) | (° C.) | (g/10 min) | shapeability | ization |
| Example 1 | TPI | 20 | PEI | 60 | carbon | 20 | 375 | 423 | 25.1 | A | A |
| | | | | | fiber | | | | | | |
| Example 2 | TPI | 30 | PEI | 40 | carbon | 30 | 376 | 493 | 22.7 | A | A |
| | | | | | fiber | | | | | | |
| Compar- | TPI | 100 | — | 0 | — | 0 | 320 | 437 | 1.99 | B | B |
| ative | | | | | | | | | | | |
| Example 1 | | | | | | | | | | | |
| Compar- | — | 0 | PEI | 100 | — | 0 | 261 | 471 | 13.8* | A | B |
| ative | | | | | | | | | | | |
| Example 2 | | | | | | | | | | | |
| Compar- | TPI | 50 | — | 0 | carbon | 50 | 314 | 399 | 2.3 | B | A |
| ative | | | | | fiber | | | | | | |
| Example 3 | | | | | | | | | | | |

*measured at a temperature of 340° C. and a load of 5.00 kgf

From Table 1, it can be understood that the resin compositions of Examples 1 and 2, which contain the first and the second thermoplastic resins and the carbonaceous filler, have favorable three-dimensional shapeability and are capable of maintaining a shape even after carbonization.

1. A resin composition suitable for producing a carbon molded body by three-dimensional printer molding and carbonization, the resin composition comprising:
a first thermoplastic resin having a residual carbon ratio of lower than 50%;
a second thermoplastic resin having a residual carbon ratio of 50% or higher; and
a carbonaceous filler dispersed in these thermoplastic resins.

2. The composition of claim 1, having a melt mass flow rate of 10 to 35 g/10 min or more in accordance with JIS K7210-01, when measured at a temperature of 360° C. and a load of 2.16 kgf.

3. The composition of claim 1, wherein the first thermoplastic resin has a melting point higher than that of the second thermoplastic resin, as measured by a thermogravimetric-differential thermal analysis (TG-DTA) in a nitrogen atmosphere at a heating rate of 10° C./min.

4. The composition of claim 1, wherein the first thermoplastic resin has a thermal decomposition temperature lower than that of the second thermoplastic resin, as measured by a thermogravimetric-differential thermal analysis (TG-DTA) in a nitrogen atmosphere at a heating rate of 10° C./min.

5. The composition of claim 1, wherein the first and the second thermoplastic resins are both a polyimide resin.

6. The composition of claim 5, wherein the first thermoplastic resin is a thermoplastic polyimide.

7. The composition of claim 5, wherein the first thermoplastic resin is a polyetherimide.

8. The composition of claim 1, wherein the content of the carbonaceous filler is in a range of from 10 to 40% by mass, with respect to a total resin composition mass.

9. The composition of claim 1, wherein the carbonaceous filler is a carbon fiber.

10. The composition of claim 1, wherein the first thermoplastic resin comprises a first polyimide resin, and
wherein the second thermoplastic resin comprises a first polyimide resin.

11. The composition of claim 1, wherein the first thermoplastic resin comprises a first polyimide resin,
wherein the second thermoplastic resin comprises a first polyimide resin, and
wherein the first polyimide resin differs from the second polyimide resin.

12. The composition of claim 1, wherein the first thermoplastic resin comprises a thermoplastic polyimide.

13. The composition of claim 5, wherein the first thermoplastic resin comprises a polyetherimide.

14. The composition of claim 1, wherein the carbonaceous filler comprises a carbon fiber.
